(19) United States
(12) Patent Application Publication
(10) Pub. No.: US 2004/0178189 A1
(43) Pub. Date: Sep. 16, 2004

(54) Electric heating unit housed in a calorie accumulator block

(76) Inventor: Bernard Peyronny, Le Thor (FR)

Correspondence Address: GREENBLUM & BERNSTEIN, P.L.C., 1950 ROLAND CLARKE PLACE, RESTON, VA, 20191, US

(21) Appl. No.: 10/486,195

(22) PCT Filed: Aug. 14, 2002
(86) PCT No.: PCT/FR02/02880

(30) Foreign Application Priority Data
Aug. 14, 2001 (FR) 0110794

(51) Int. Cl. H05B 3/06

(52) U.S. Cl. 219/530

(57) ABSTRACT

The invention relates to an electric heating unit which is housed in a calorie accumulator block. The invention comprises an accumulator block (2) which is made from light alloy, cast iron, ceramic or another material. Said block houses a flat resistor (1) which is disposed between two high-temperature insulating sheets (6, 7) and which comprises a dished resistive plate or a tape wound on a flat insulating support. In general terms, the invention relates to the industrial and commercial field for the production and distribution of basic and auxiliary heating devices that are intended for all types of locations, such as dwellings, houses, offices, shops and other private or professional locations.

The present invention relates to an electric heating body embedded in a calorie accumulator block.

Generally speaking, it relates to the industrial and commercial field for the production and distribution of primary and auxiliary heating apparatuses that are adapted for all types of premises, such as dwellings, houses, offices, stores, or other private or professional premises.

Currently, central heating systems are increasingly abandoned in favor of self-contained individual units, particularly in residential premises and offices, due to the difficulties to control and optimize energy consumption in large installations.

Electric heating apparatuses generally are radiators constituted of a casing made of steel sheet, provided with an air inlet and outlet and including a single resistance. In most cases, the control is ensured by a thermostat integrated in the apparatus, and in rare cases, by a more developed system that can comprise zone thermostats, an external thermostat, and possibly a scheduler or a power cut-off device.

The control of the current electric radiators is typically an on-off control between two nearly equal temperatures (“differential”). The heat source is alternately shut-off and cold, then connected at its maximum temperature. Recent studies have shown that the impression felt does not correspond to the mean temperature, but rather to the actual lowest temperature. As a result, the need for comfort often leads users to set the thermostat several degrees above the desired temperature, which results in a significant waste of energy.

The U.S. Pat. No. 2,721472, filed on Jun. 15, 1994 by the same inventor, describes an electric heating unit constituted of a metallic or non-metallic enclosure containing, in its lower portion, a heating body constituted of a shielded resistance (resistive wire confined in an insulant and in a metallic tube) embedded in a light alloy metallic unit, this heating body being separated from the enclosure by spacers, such that the metallic unit is entirely surrounded by an air cushion, the control of the system being carried out by an electronic device that cuts power for a variable time period during a cycle of about several seconds.

This device makes it possible to produce electric radiators in which the temperature of the heat source does not vary substantially. These apparatuses further have the advantage of accumulating thermal energy while being more compact than the usual accumulation systems, which makes it possible to house them in, for example, communicating doors.

The device according to the invention consists of an improvement to the heating body described in the cited patent, and has the primary object of allowing a reduction in the manufacturing cost by implementing proven techniques derived from those that have already been used in various applications, such as small electric household appliances (iron, hair dryer, etc.).

It is constituted of an accumulator block made of light alloy, cast iron, ceramic or the like, confining a flat resistor arranged between two high--temperature insulating sheets and formed of a dished resistive plate or of a tape wound on an insulating support.

In the annexed drawings, provided by way of non-limiting examples of embodiment of the object of the invention:

FIGS. 1 and 2 are partial views showing two variations of flat resistors;

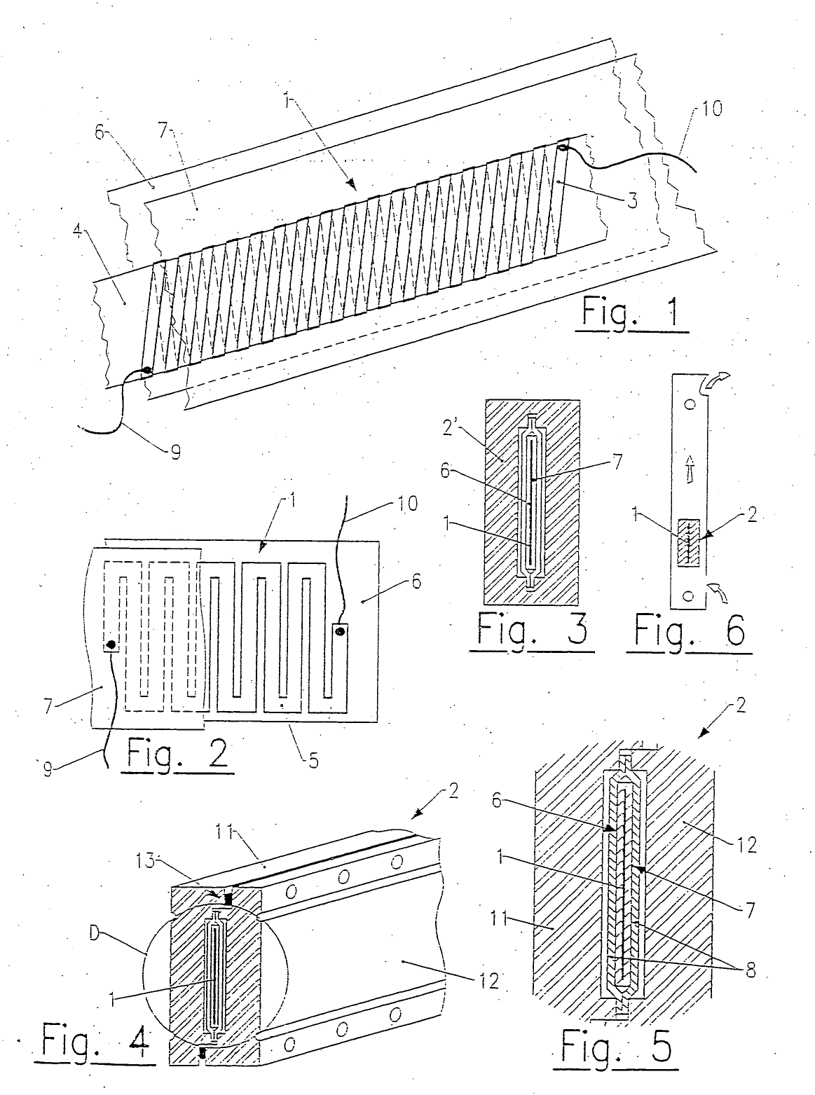

FIG. 3 is a transverse cross-section of an accumulator block constituted of a metallic section,

FIG. 4 is a transverse cross-section of a heating body formed by the assembly of two plates confining a flat resistor,

FIG. 5 is an enlargement of the detail D of FIG. 4,

FIG. 6 schematically shows a cross-section of a radiator equipped with a heating body according to the invention, and

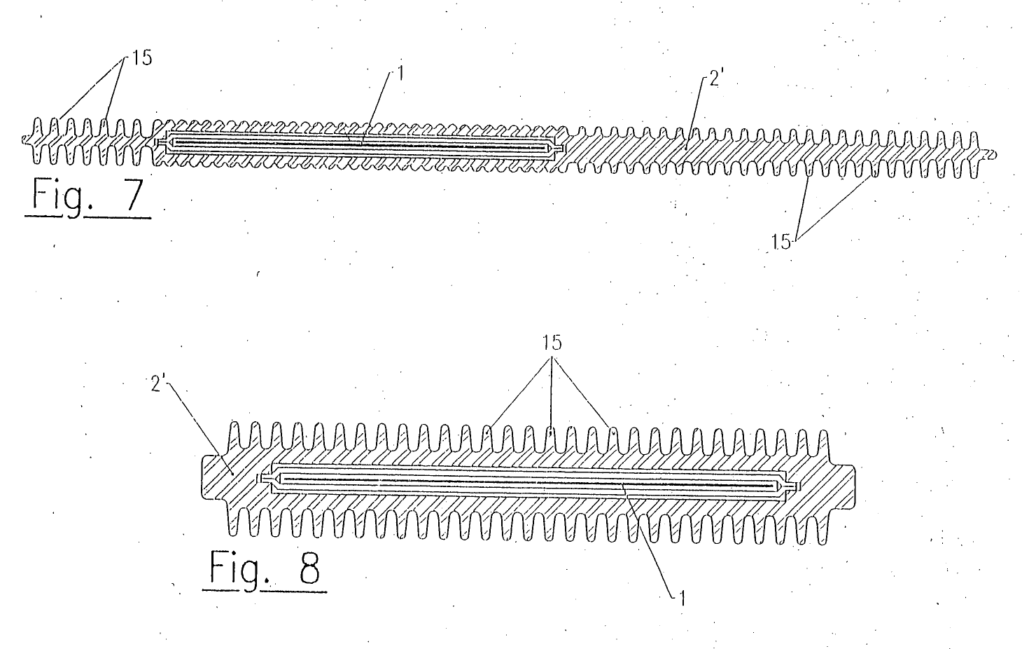

FIGS. 7 and 8 are transverse cross-sections of an accumulator block constituted of a metallic section comprising wings for heat diffusion.

The device, FIGS. 1-6, is constituted of an insulated flat resistor 1 inserted into an accumulator block 2 that is capable of storing the calories.

The resistor 1 consists of an elongated element made of a resistive material in the form of a resistive tape 3 wound on a flat insulating support 4 (FIG. 1) or of a dished plate 5 cut out to form a series of meanders (FIG. 2).

This resistor is enclosed between two insulating sheets 6, 7 resisting high temperatures, made of composite mica or of any other material having good heat stability.

In the case where a double insulation is necessary (Class II radiators), an additional high-temperature insulation 8 is positioned on each side of the flat resistor 1, which is itself already insulated. To obtain continuity of the additional insulation, the latter is advantageously constituted of two sheets that overlap the assembly formed by the primary insulation and the resistive element, the edges of these sheets being pressed against one another to form a closed envelope (FIG. 5).

In the same manner, the two connecting wires 9, 10 can have a double insulation.

The accumulator block 2 is preferably made of an aluminum-base light alloy, but it can be made of cast iron, ceramic, or of any other material that is capable of storing heat.

It can be extruded (in the case of aluminum) and machined to form a hollow metallic section 2′ (FIG. 3). In order to improve the diffusion of heat, the outer walls of the section are advantageously structured in the form of wings 15 (FIGS. 7 and 8).

The accumulator block 2 can also be constituted of two metallic plates 11, 12 assembled by clips, by screwing or by riveting, the flat resistor 1 being “sandwiched” between these two plates.

As an alternative, the flat resistor 1 can be molded in an aluminum or a cast iron mass (gravity molding of the mass), but this is a more difficult technique to implement.

For the Class II apparatuses, the entire heating body 2 must be waterproof. The waterproofness can be obtained by one or two joints 13 positioned at the interface of the two metallic plates 11, 12.

The positioning of the various constitutive elements provides the object of the invention with a maximum of useful effects which had not, to date, been obtained by similar devices.

1. Electric heating body embedded in a calorie accumulator block, adapted for the manufacture of primary and auxiliary heating apparatuses for all types of premises, such as dwellings, houses, offices, stores, or other private or professional premises,
characterized in that it is constituted of an insulated flat resistor (1) inserted within an accumulator block (2, 2′) that is capable of storing the calories.

2. Heating body according to claim 1, characterized in that the accumulator block is constituted of an extruded metallic section (2′).

3. Heating body according to claim 1, characterized in that the metallic section (2′) comprises outer walls structured in the form of wings (15) for heat diffusion.

4. Heating body according to claim 1, characterized in that the accumulator block (2) is constituted of the assembly of two metallic plates (11, 12) made of aluminum-base light alloy or of cast iron.

5. Heating body according to claim 1, characterized in that the accumulator block (2) is constituted of the assembly of two plates (11, 12) made of ceramic.

6. Heating body according to claim 1, characterized in that the flat resistor (1) is molded in an aluminum mass.

7. Heating body according to any of the preceding claims, characterized in that the flat resistor (1) is constituted of an elongated element in the form of a resistive tape (3) wound on a flat insulating support (4).

8. Heating body according to any of claims 1-6, characterized in that the flat resistor (1) is constituted of an elongated element made of a resistive material of a dished plate (5) cut out to form a series of meanders.

9. Heating body according to any of the preceding claims, characterized in that the flat resistor (1) is arranged between two insulating sheets (6, 7) resisting high temperatures, made of composite mica or of any other material having good heat stability.

10. Heating body according to any of the preceding claims, characterized in that an additional high-temperature insulation (8) is positioned on each side of the flat resistor (1), so that the device is compliant with the Class II arrangements for electric apparatuses.

11. Heating body according to claim 10, characterized in that of the additional insulation (8) is constituted of two sheets that overlap the assembly formed by the primary insulation and the flat resistor (1), the edges of these sheets being pressed against one another to form a closed envelope.
